(19) United States
(12) Patent Application Publication
(10) Pub. No.: US 2025/0083280 A1
(43) Pub. Date: Mar. 13, 2025

(54) DYNAMIC COLLECTION DEVICE FOR OIL FILM AND TEMPERATURE DISTRIBUTION IN GRINDING ZONE AND OPERATING METHOD THEREOF

(71) Applicant: QINGDAO UNIVERSITY OF TECHNOLOGY, Shandong (CN)

(72) Inventors: Yanbin ZHANG, Shandong (CN); Wenyi LI, Shandong (CN); Xin CUI, Shandong (CN); Changhe LI, Shandong (CN); Zongming ZHOU, Shandong (CN); Shuaiqiang XU, Shandong (CN); Bo LIU, Shandong (CN); Yun CHEN, Shandong (CN)

(73) Assignee: QINGDAO UNIVERSITY OF TECHNOLOGY, Shandong (CN)

(21) Appl. No.: 18/570,639

(22) PCT Filed: Jul. 19, 2023
(86) PCT No.: PCT/CN2023/108146

§ 371 Date: Dec. 15, 2023

(30) Foreign Application Priority Data
Jan. 10, 2023 (CN) 202310033783.2

(51) Int. Cl. B24B 49/12; B24B 41/06; B24B 49/14; B24B 55/02

(52) U.S. Cl. CPC B24B 49/12; B24B 41/06; B24B 49/14; B24B 55/02

(57) ABSTRACT

Provided in the present invention are a dynamic collection device for an oil film and temperature distribution in a grinding zone and an operating method thereof. A spectroscope and a 45-degree flat mirror are utilized to carry out optical imaging of the permeation and infiltration of the grinding fluid in a grinding zone during a grinding process, and a video signal imported into a high-speed camera is converted into a digital signal processed by a CCD photosensitive element, and a dynamic image is imported for dynamic collection. Infrared radiation emitted from the grinding zone is reflected through the 45-degree flat mirror, and transmitted to the thermal imaging camera, and the signal is transmitted to an internal infrared detector. The infrared detector adjusts and amplifies the received signal and outputs it to an infrared thermal imaging chip. After image processing, the temperature distribution image is imported for dynamic collection.

The present invention claims the priority of a Chinese patent application with an application number 202310033783.2 submitted to the Chinese Patent Office on Jan. 10, 2023, and titled “Dynamic collection device for oil film and temperature distribution in grinding zone and operating method thereof”, the whole content of which is incorporated in the present invention by reference.

### FIELD OF TECHNOLOGY

The present invention belongs to the field of grinding device, and in particular relates to a dynamic collection device for oil film and temperature distribution in a grinding zone and an operating method thereof.

### BACKGROUND

The statements in this part only provide background technical information related to the present invention and do not necessarily constitute the prior art.

Grinding process is an important technology, in which cooling lubrication medium plays an important role. Supply methods of lubrication medium include pouring type, micro-lubrication, nano-fluid micro-lubrication, etc. Nano-fluid micro-lubrication solves the problem of green high-performance grinding. The nano-fluid micro-lubrication grinding uses vegetable oil base oil and solid particles with a particle size less than 100 nm to prepare highly dispersed green nano-fluid as lubricant, which is supplied to a grinding zone with a flow rate as low as 5% of that of the pouring type under high-pressure gas atomization. Due to characteristics of degradable and precise micro-supply of the nano-fluid lubricant, green manufacturing of the grinding process is realized. Furthermore, compared with a traditional pouring type and micro-lubrication supply method, the introduction of nano-particles significantly improves convective heat transfer performance of the micro-lubricant through its unique micro-movement and heat transfer micro-channels, and significantly enhances lubrication performance due to excellent anti-friction and anti-wear properties of nano-particles in the grinding zone.

In a process of turning, an infiltration space formed by a tool/workpiece interface is a single capillary structure, while a grinding zone/workpiece interface has surface characteristics such as abrasive particles, pores, micro-convex and micro-pits. In a process of grinding wheel/workpiece interface grinding, a complex micro-nano channel network would be formed, which is more likely to provide channels for lubricant infiltration. A geometric mathematical model of micro-channels and network of shallow grinding wheel/workpiece interface has been established in some researches, and morphology and surface microscopic characteristics of the micro-channels and network are quantitatively characterized. However, due to high-speed relative movement of the grinding wheel and workpiece and characteristics of a high temperature domain, the infiltration of nano-fluid at the interface becomes an extremely complicated hydrodynamic behavior.

For the capillary infiltration and temperature distribution of the micro-nano channels of lubrication fluid, there is currently no device to realize dynamic collection during the grinding, and quality of infiltration performance can only be reflected from aspects such as a wear condition of the abrasive particles and surface roughness of the workpiece. In order to better reveal a change mechanism of nano-fluid viscosity and surface tension under coupling of multi-physical field, grinding zone temperature field and coupling of nano-fluid parameters (a nano-particle type, a base oil type, a nano-fluid concentration), it is very important to carry out a series of researches such as exploring an infiltration mechanism in complex randomly distributed micro-nano channels in the grinding zone, revealing pump suction effect of a capillary negative pressure, capillary adhesion effect and thermal traction effect, exploring a nano-infiltration behavior under coupling of multi-physical field traction and geometric characteristics of the micro-channels, so as to establish a device which can realize the dynamic collection of permeation and infiltration of the lubrication fluid and temperature distribution in a grinding process.

Disclosed in a Chinese patent CN201711278067.1 is a nano-fluid micro-lubrication grinding device with ultrasonic vibration assisted grinding fluid micro-channel infiltration, which solves a problem that the thickness of undeformed grinding chips has a great influence on a grinding process in the prior art. From a microscopic viewpoint, a lubrication state of a single abrasive particle when a material is removed in the grinding process is fully considered, which effectively realizes the effect of ultrasonic vibration assisted grinding on improving the micro-lubrication cooling lubrication of nano-fluid. The ultrasonic assisted grinding is used to explore cooling lubrication performance of grinding fluid infiltration, but there is no device for dynamic collection of permeation and infiltration of the grinding fluid and temperature distribution, and it is not possible to directly observe infiltration film formation of the grinding fluid and temperature distribution in the field of vision, and it is not possible to more accurately reflect improvement of infiltration cooling lubrication performance of the grinding fluid.

Disclosed in a Chinese patent CN202111422746.8 is a multi-energy field nano-lubricant micro-scale bone grinding measurement system, which comprehensively considers coupling effect of ultrasonic vibration, nano-fluid and charged atomization, and can detect nano-particle micro-droplets, a grinding temperature and a grinding force in real time online. However, the device only detects a movement trajectory of the micro-droplets, the grinding temperature and the grinding force in real time, without dynamic collection of permeation and infiltration of grinding fluid. It can neither directly observe infiltration film formation of grinding fluid and temperature distribution in the field of vision, nor it uses an optical dynamic collection system with accuracy of a micro-nano level, which could not ensure the accuracy of data. Moreover, a detection system thereof has no movement control in positions and cannot detect micro-droplets from a plurality of angles.

Disclosed in a China utility model CN202120664399.9 is a bowl-shaped grinding wheel face grinding cemented carbide blade online detection device, wherein a workpiece thereof is clamped on a force meter, the force meter is electrically connected with a charge amplifier of the force meter through a wire, the charge amplifier of the force meter is electrically connected with a data collector of the force meter through a wire, the data collector is electrically connected with a computer processing device through a wire, an infrared thermometer is used to detect a grinding temperature of a grinding wheel, a laser displacement sensor is used to detect an axial displacement of the grinding wheel. It can realize a real-time tracking detection of a grinding process, so as to adaptively adjust the speed and feed rate of a grinding wheel feed system, making the grinding process more efficient and stable. However, the device is only suitable for an online detection of a face grinding machine, and can not be used on a flat grinding machine, and it can only detect a grinding temperature of the grinding wheel online, and can not detect permeation and infiltration of lubrication fluid and a temperature distribution in a grinding zone online, and can not directly observe infiltration film formation of grinding fluid and temperature distribution in the field of vision.

It can be seen that although there are currently multi-physical field assisted grinding devices, nano-fluid micro-lubrication cutting grinding devices and tool optical detection systems, there are the following problems: 1) there is no design for online collection of permeation and infiltration performance of grinding lubrication fluid and a dynamic temperature distribution, and there is no similar technical solution at present; 2) no optical detection system is used to dynamically collect the permeation and infiltration of the lubrication fluid or the temperature distribution in the grinding zone; 3) the position and object distance of a detection mirror group are not adjusted according to the requirements of dynamic collection, so that a dynamic image is in an optimal detection state; 4) there is no design of a dynamic collection device that effectively combines a clamp body structure with the optical detection system.

### SUMMARY

In order to overcome the shortcomings of the prior art, the present invention provides a dynamic collection device for oil film and temperature distribution in a grinding zone and an operating method thereof. Through cooperation of a clamp body structure and an optical detection system structure, permeation and infiltration performance of lubrication fluid and a dynamic temperature distribution in a grinding zone is dynamically collected, and film formation of the grinding fluid and the temperature distribution are visually displayed in the field of vision, which more accurately reflects the improvement of wetting cooling lubrication performance of the grinding fluid.

To achieve the above purposes, one or more embodiments of the present invention provide the following technical schemes:

A first aspect of the present invention provides a dynamic collection device for an oil film and a temperature distribution in a grinding zone.

A dynamic collection device for an oil film and temperature distribution in a grinding zone, wherein the dynamic collection device comprises a clamp body structure, an optical detection system structure and a magnetic workbench;
the magnetic workbench adsorbs and fixes the clamp body structure, the optical detection system structure is fixed and connected to the clamp body structure, and a workpiece is fixed on the clamp body structure; and
in a grinding process of the workpiece, the clamp body structure images the grinding zone, and transmits an image to an optical detection system structure, the optical detection system structure adjusts a lens distance and a horizontal position according to a grinding situation, and carries out signal processing, and finally generates an image of permeation and infiltration film formation of lubrication fluid and the dynamic temperature distribution.

Further, the clamp body structure comprises a clamp body shell, an adsorption chassis, a clamping assembly and a telescopic sealing assembly;
the clamp body shell is fixed on the adsorption chassis, and the adsorption chassis is energized and adsorbed by the magnetic workbench;
the clamping assembly is fixed on an upper surface of the clamp body shell and is used for clamping and fixing the workpiece from a side; and
the telescopic sealing assembly is installed in an internal cavity groove of the clamp body shell, is used to abut against a bottom of the workpiece so as to form a sealing structure, and images the grinding zone through a mirror group in the sealing structure.

Further, the clamping assembly comprises a support plate, a first positioning plate and a micro hydraulic clamping mechanism mounted on the clamp body shell; and
the workpiece is placed on the support plate, and is in contact with the first positioning plate and positioning nails to achieve six-point positioning, and an upper end of the workpiece is clamped by the micro hydraulic clamping mechanism.

Further, the telescopic sealing assembly comprises a boss, a moving platform and the mirror group;
the boss is mounted in the internal cavity groove of the clamp body shell, and an inner part of the boss is a square internal hollowed structure;
the mirror group is mounted in the internal hollowed structure of the boss, comprising a spectroscope and a 45-degree flat mirror, wherein the spectroscope is arranged facing a detection area of the workpiece, and the 45-degree flat mirror is vertically placed at a bottom of the spectroscope; and
the moving platform is mounted on a side of the boss, and is driven by a motor to rise vertically along the boss to abut against the bottom of the workpiece; and the moving platform, the boss and the workpiece form the sealing structure.

Further, the optical detection system structure comprises a lead screw moving platform, a detection mirror group and a connecting rotary buckle;
the detecting mirror group is fixed on the lead screw moving platform, and controls left and right movements of the detecting mirror group by the moving platform; and
the connecting rotary buckle is used to fix and be connected with the clamp body structure, so that the detection mirror group on the lead screw moving platform is facing the mirror group in the clamp body structure.

Further, the lead screw moving platform adopts a motor lead screw mechanism to control a rotating distance of a lead screw through a motor, so that the moving platform moves within a range of micron level, and adjusts a position of the detection mirror group according to dynamic collection demands.

Further, the detection mirror group comprises an infinite-distance objective lens, a focusing cylinder, an extension cylinder, a camera and an imaging element successively connected;
wherein the camera is a high-speed camera or thermal imaging camera, and the imaging element is a CCD photosensitive element or an infrared thermal imaging chip, and the high-speed camera and the CCD photosensitive element are used when collecting the permeation and infiltration film formation of the lubrication fluid, and the thermal imaging camera and the infrared thermal imaging chip are used when collecting the dynamic temperature distribution.

A second aspect of the present invention provides an operating method of a dynamic collection device for an oil film and a temperature distribution in a grinding zone.

An operating method of a dynamic collection device for an oil film and temperature distribution in a grinding zone, the method comprising:
configuring the dynamic collection device according to dynamic collection demands;
in the grinding process of the workpiece, imaging the grinding zone by utilizing the configured dynamic collection device, and carrying out the signal processing, and finally generating an image of permeation and infiltration film formation of lubrication fluid and the dynamic temperature distribution;
wherein the dynamic collection demands are divided into the permeation and infiltration film formation of the lubrication fluid and the dynamic temperature distribution.

Further, configuring the dynamic collection device is specifically as follows:
if the image of the permeation and infiltration film formation of the lubrication fluid is generated, mounting the spectroscope and fixing the spectroscope by a spectroscope stopper, and turning on a controllable LED light strip and adjusting brightness thereof by an external remote control; and
if the image of the dynamic temperature distribution is generated, removing the spectroscope and turning off the controllable LED strip.

Further, the dynamic collection device adjusts a horizontal position and a focal length of the detection mirror group through two ways of coarse adjustment and fine adjustment.

The above one or more technical schemes have the following beneficial effects:
the device of the present invention dynamically collects the permeation and infiltration performance of the lubrication fluid and the temperature distribution in the grinding zone, visually displays the infiltration film formation of the grinding fluid and the temperature distribution in the field of vision, and more accurately reflects the improvement of the infiltration cooling and lubrication performance of the grinding fluid.

The device of the present invention adopts the clamp body structure comprising the clamping assembly and the telescopic sealing assembly as well as the optical detection system structure comprising a box body, the lead screw moving platform, the detection mirror group and the connecting rotary buckle. The clamp body structure and the optical detection system structure can be well matched together during the grinding, which plays an excellent dynamic collection function for the infiltration film formation performance of the lubrication fluid and dynamic temperature distribution.

The detection mirror group of the present invention adopts a stacked microscope group structure, and a high-speed camera or thermal imaging camera with the main collection function at a rear end can effectively detect the permeation and infiltration condition of the lubrication fluid or the temperature of the grinding zone during the grinding with the cooperation of various mirror groups in the front, and the focusing adopts the motor to drive a belt wheel to rotate. The motor with a precise control function can control a distance of the pulley rotation within a certain precision, so that a focusing cylinder can perform telescopic focusing in the range of a micron level, which is conducive to strengthening the clarity and visibility of dynamic images during the collection, and the dynamic collection and data analysis can produce more intuitive effects.

The clamping assembly of the present invention adopts five micro-hydraulic clamping mechanisms, four of which are placed symmetrically in front and back, and the other one is placed on a side to provide thrust fastening effect during the grinding. As a whole, the acrylic glass workpieces of different thickness can be clamped and fixed to ensure the stability of the acrylic glass workpieces during the grinding, which facilitates the collection of the infiltration area of the lubrication fluid in a later period.

The telescopic sealing assembly of the present invention adopts a motor to drive a gear rack mechanism to drive a slide block of a guide rail to move, so that the moving platform rises vertically along the boss and is abutted against the bottom of the acrylic glass workpieces. With a plurality of sealing cooperations of the sealing strips and the sealing plates, the mirror group inside the boss would not be polluted by the lubrication fluid and chips, so as to obtain good sealing. The controllable LED light strip inside the boss can provide sufficient lighting intensity and eliminate the reflective effect of the acrylic glass workpiece under a coaxial lighting technology of the spectroscope, which is more conducive to the image collection of the optical detection system.

The box body of the present invention adopts a box body structure to cover all the detection mirror group and the lead screw moving platform, which not only ensures that the detection mirror group and the lead screw moving platform are not polluted by the lubrication fluid and chips, but also ensures that a dark and closed environment of the detection mirror group is not interfered by external light, which is conducive to the detection mirror group to better dynamically collect in the permeation and infiltration zone of the lubrication fluid.

The lead screw moving platform of the present invention adopts the motor lead screw mechanism, and the motor with the precise control function can control a rotating distance of the lead screw in a certain precision, so that the moving platform can move in a range of micron level, and on the whole, it is embodied as the left and right control movement of the detection mirror group, which is conductive to adjustment of the position of the detection mirror group according to the dynamic collection demands in the permeation and infiltration of the lubrication fluid during the grinding, thus facilitating better collection.

The connecting rotary buckle of the present invention adopts a rotary buckle structure. The rotary buckle on the sealing plate of the clamp body and the rotary buckle of the sealing plate of the detection mirror group make the clamp body structure be connected and fixed with the optical detection system structure through the rotating cooperation, which can not only effectively ensure that the detection mirror group and the lead screw moving platform are not polluted by the lubrication fluid and chips, but also ensure the dark and closed environment of the detection mirror group without interference from external light. A flexible protective cover on the sealing plate of the clamp body can also play cushion-shock effect during the grinding, which ensures the stability of the overall optical detection system, and is conductive to dynamic collection of the detection mirror group in the permeation and infiltration zone of the lubrication fluid.

The advantages of additional aspects of the present invention are partly given in the description below, and partly become apparent from the description below, or become known through the practice of the present invention.

### BRIEF DESCRIPTION OF THE DRAWINGS

The accompanying drawings forming a part of the present invention are used to provide further understanding of the present invention, and the schematic embodiments of the present invention and their descriptions are used to interpret the present invention and do not constitute undue limitations of the present invention.

FIG. 1 (a) is a schematic diagram of an optical detection system;

FIG. 1 (b) is a flow chart of collection of permeation and infiltration of lubricating fluid;

FIG. 1 (c) is a flow chart of collection of a dynamic temperature distribution;

FIG. 2 is a final assembly axonometric diagram in a first embodiment;

FIG. 3 is an explosion view of a first layer of a clamp body structure in the first embodiment;

FIG. 4 is an axonometric diagram of the clamp body structure in the first embodiment;

FIG. 5 is a front sectional view of a clamping assembly of the clamp body in the first embodiment;

FIG. 6 is a side sectional view of the clamping assembly of the clamp body in the first embodiment;

FIG. 7 is a top sectional view of the clamping assembly of the clamp body in the first embodiment;

FIG. 8 is an explosion view of a second layer of the clamp body structure in the first embodiment;

FIG. 9 is a front sectional view of a telescopic sealing assembly of the clamp body in the first embodiment;

FIG. 10 is a side sectional view of the telescopic sealing assembly of the clamp body in the first embodiment;

FIG. 11 is an explosion view of a third layer of the clamp body structure in the first embodiment;

FIG. 12 is a top view of the telescopic sealing assembly of the clamp body in the first embodiment;

FIG. 13 is a sectional view of A-A and B-B directions of the telescopic sealing assembly of the clamp body in the first embodiment;

FIG. 14 (a) is a first axonometric diagram of a clamp body shell in the first embodiment;

FIG. 14 (b) is a second axonometric diagram of the clamp body shell in the first embodiment;

FIG. 14 (c) is a third axonometric diagram of the clamp body shell in the first embodiment;

FIG. 14 (d) is a front view of the clamp body shell in the first embodiment;

FIG. 14 (e) is a side view of the clamp body shell in the first embodiment;

FIG. 14 (f) is a top view of the clamp body shell in the first embodiment;

FIG. 15 is a side sectional view of the telescopic sealing assembly of the clamp body in the first embodiment;

FIG. 16 is an explosion diagram of a telescopic sealing platform in the first embodiment;

FIG. 17 is a front sectional view of the telescopic sealing platform in the first embodiment;

FIG. 18 is a side sectional view of the telescopic sealing platform in the first embodiment;

FIG. 19 is an axonometric diagram of a boss in the first embodiment;

FIG. 20 is a sectional view of the boss in a C-C direction in the first embodiment;

FIG. 21 is an axonometric diagram of an optical detection system structure in the first embodiment;

FIG. 22 is a side sectional view of a box body of the optical detection system in the first embodiment;

FIG. 23 is an axonometric diagram of a detection mirror group of the optical detection system in the first embodiment;

FIG. 24 is a front sectional view of the detection mirror group of the optical detection system in the first embodiment;

FIG. 25 is a top sectional view of the detection mirror group of the optical detection system in the first embodiment;

FIG. 26 is an axonometric diagram in which the clamp body structure and the optical detection system structure in the first embodiment are connected;

FIG. 27 is a side sectional view in which the clamp body structure and the optical detection system structure in the first embodiment are connected;

FIG. 28 is an axonometric diagram of the clamp body structure and a connecting rotary buckle in the first embodiment;

FIG. 29 is a sectional view of the connecting rotary buckle in a D-D direction in the first embodiment;

FIG. 30 is an axonometric diagram of the clamp body structure in a second embodiment;

FIG. 31 is a top view of a clamping assembly of the clamp body structure in the second embodiment;

FIG. 32 is a front sectional view of the clamping assembly of the clamp body structure in the second embodiment.

In the figures, I clamp body structure, II optical detection system structure, III magnetic workbench, IV grinding wheel and V acrylic glass workpiece;
I-1 clamp body shell, I-1-1 support plate fixing slot, I-1-2 hydraulic mechanism fixing slot, I-1-3 hydraulic system groove, I-1-4 internal cavity groove, I-1-5 motor slot, I-1-6 detection hollowed area, I-2 adsorption chassis, I-3 clamping assembly, I-3-1 first positioning plate, I-3-2 micro-hydraulic clamping mechanism, I-3-3 second positioning plate, I-3-4 hydraulic clamping mechanism fixing sealing plate, I-3-5 positioning nail, I-3-6 support plate, I-3-7 vacuum sucker fixing sealing plate, I-3-8 vacuum sucker, I-4 telescopic sealing assembly, I-4-1 45-degree flat mirror, I-4-2 flat mirror splint, I-4-3 flat mirror bottom plate, I-4-4 motor cover, I-4-5 guide rail slide block, I-4-6 boss, I-4-6-1 square internal hollowed structure, I-4-6-2 side hollowed structure, I-4-6-3 chute structure, I-4-7 motor sealing plate, I-4-8 gear, I-4-9 guide rail, I-4-10 spectroscope, I-4-11 first micro motor, I-4-12 controllable LED light strip, I-4-13 gear rack, I-4-14 moving platform, I-4-15 spectroscope stopper, I-4-16 spectroscope stopper bottom plate, I-5 boss sealing plate, I-5-1 boss sealing plate bottom groove, I-6 first sealing strip, I-7 second sealing strip, I-8 third sealing strip, I-9 shell groove;
II-1 placing platform, II-2 computer, II-3 box body, II-3-1 box body, II-3-2 circular gradienter, II-3-3 data line, II-3-4 box body chassis, II-3-5 adjustable leg, II-3-6 plug, II-4 lead screw moving platform, II-4-1 second micro motor, II-4-2 first motor seat, II-4-3 first bearing seat, II-4-4 connecting bottom plate, II-4-5 second bearing seat, II-4-6 moving platform bottom plate, II-4-7 moving platform, II-4-8 second motor seat, II-4-9 third micro motor, II-4-10 pulley, II-4-11 synchronous belt, II-4-12 lead screw, II-4-13 coupling, II-5 detection mirror group, II-5-1 high-speed camera/thermal imaging camera, II-5-2 camera adapter ring, II-5-3 first extension cylinder, II-5-4 anchor ear, II-5-5 second extension cylinder, II-5-6 first focusing cylinder component, II-5-7 second focusing cylinder component, II-5-8 tube mirror, II-5-9 infinite objective lens adapter ring, II-5-10 infinite objective lens, II-5-11 fixing pin, II-6 connecting rotary buckle, II-6-1 detection mirror group sealing plate, II-6-1-1 detection mirror group sealing plate rotary buckle, II-6-2 clamp body sealing plate, II-6-2-1 flexible protective cover, II-6-2-2 clamp body sealing plate rotary buckle.

### DESCRIPTION OF THE EMBODIMENTS

The present invention is further explained in combination with the drawings and embodiments below.

### First Embodiment

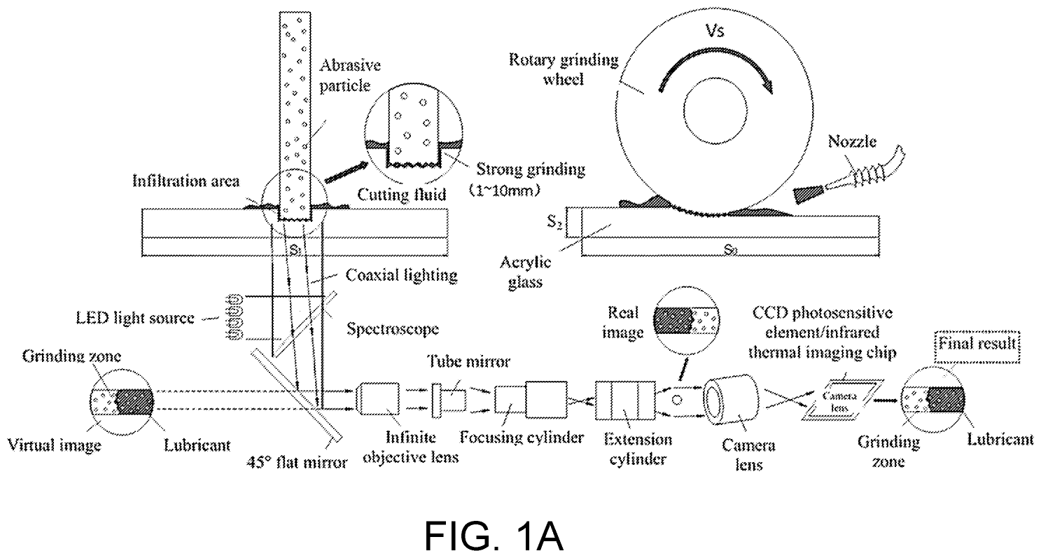

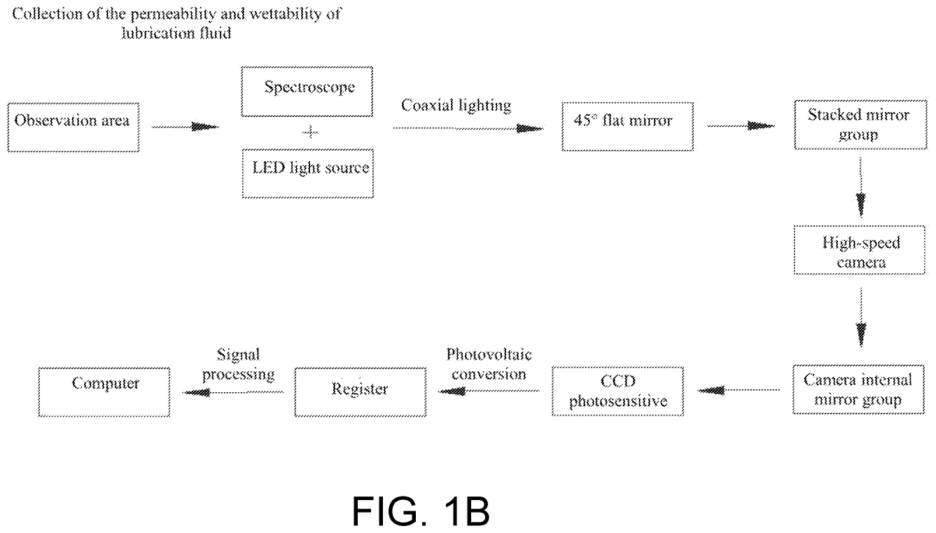

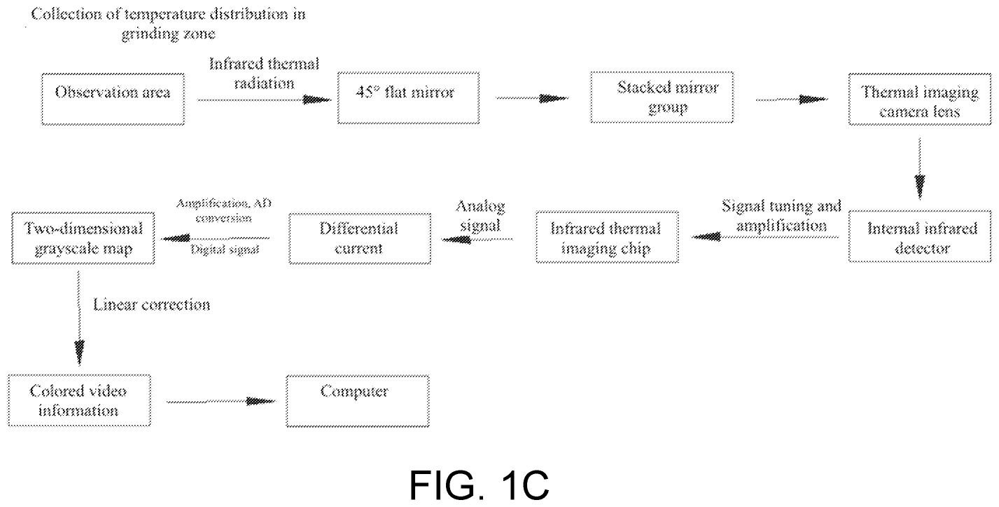

Discloses in this embodiment is a dynamic collection device for an oil film and a temperature distribution in a grinding zone. As shown in FIG. 1 (a), FIG. 1 (b) and FIG. 1 (c), a principle of an optical detection system is explained by taking strong deep grinding as an example. When a grinding begins, a complex micro-nano channel network would be formed during a grinding wheel/workpiece interface grinding process to provide channels for impregnating agent. In order to collect a permeation and infiltration condition of lubrication fluid, in a strict sealing and excellent dark environment, a controllable LED light strip on one side not only provides sufficient light intensity for the grinding zone, but also can be combined with a spectroscope (a coaxial light lighting technology) to effectively eliminate negative effect of reflection generated by an acrylic glass workpiece itself. Furthermore, according to needs, an external remote control can control opening and closing of the LED light strip and change of brightness. A 45-degree flat mirror is vertically placed at the bottom of the spectroscope so as to reflect an image of the grinding zone into an infinite objective lens. A tube mirror is used in combination with the infinite objective lens, so as to make perfect correction on the aberration of the objective lens, and the combined objective lens has a wide field of view. A focusing cylinder can adjust the size of an object distance according to the needs of dynamic collection, which is conducive to the clarity of a final image. Moreover, the focusing cylinder can support the tube mirror to focus at an infinite distance under various flange distances, but a distance between focused light and a photosensitive element is long, so it is necessary to use an extension cylinder, of which the function is to shorten the focusing distance of the lens and improve the macro performance of the lens. Finally, the image is converted into a video signal through a camera lens of a high-speed camera, and an internal CCD photosensitive element receives the video signal and performs a series of processing, and finally imports the processed signal to a screen of a computer through a data line for observation.

When the dynamic temperature distribution of the grinding zone is collected, the controllable LED light strip is turned off by the external remote control, and the spectroscope is removed from the inside of a boss to avoid interference with the infrared radiation emitted from the grinding zone by an external light temperature and unnecessary reflection. The high-speed camera is replaced by a thermal imaging camera, and a grinding detection begins after the overall equipment is sealed. A camera of the thermal imaging camera transmits a signal to an internal infrared detector, the infrared detector adjusts and amplifies the received signal and outputs the amplified signal to an infrared thermal imaging chip. After a series of image processing, a temperature distribution image is imported, through the data line, into the screen of the computer for dynamic collection.

As shown in FIG. 2, a dynamic collection device for an oil film and temperature distribution in a grinding zone, wherein the dynamic collection device comprises a clamp body structure I, an optical detection system structure II, a magnetic workbench III, a grinding wheel IV and an acrylic glass workpiece V;

The magnetic workbench III can adsorb and fix the clamp body structure I, the clamp body structure I can locate and clamp the acrylic glass workpiece V, the grinding wheel IV performs grinding on the acrylic glass workpiece V while the optical detection system structure II can adjust a lens distance and a horizontal position according to a grinding condition, which can achieve a better image collection function.

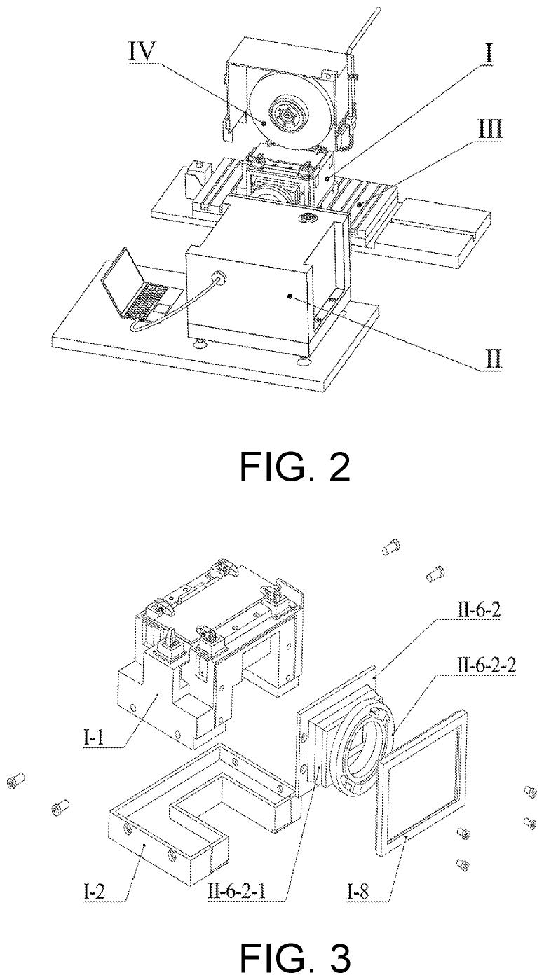

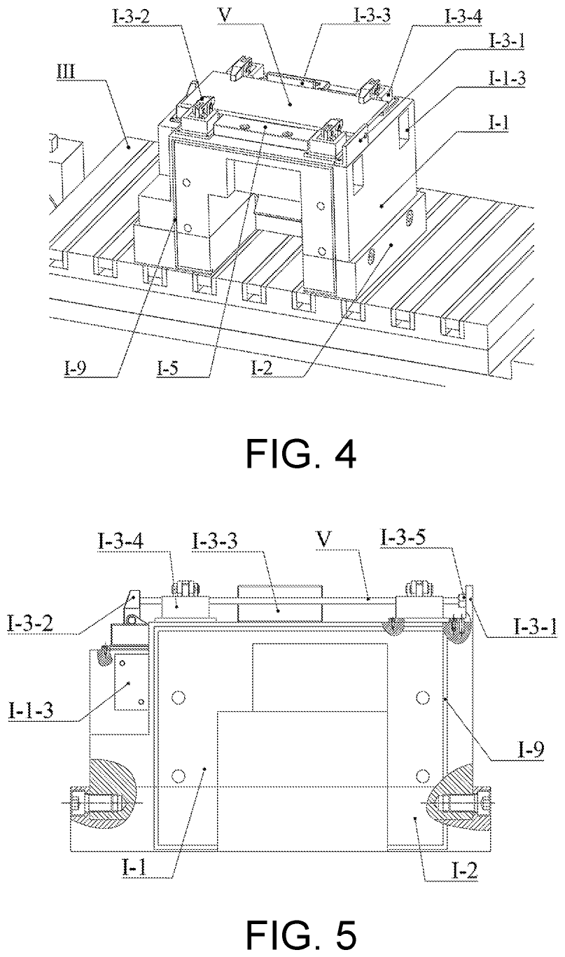

As shown in FIG. 2, FIG. 3 and FIG. 4, the clamp body structure I comprises a clamp body shell I-1, an adsorption chassis I-2, a clamping assembly I-3, a telescopic sealing assembly I-4, a boss sealing plate I-5, a first sealing strip I-6, a second sealing strip I-7, and a third sealing strip I-8. The adsorption chassis I-2 is made of a steel material and can be energized and absorbed by the magnetic workbench III, and the clamp body shell I-1 made of an aluminum alloy material can be fixed on the adsorption chassis to ensure the overall stability of the clamp body structure I in the grinding process.

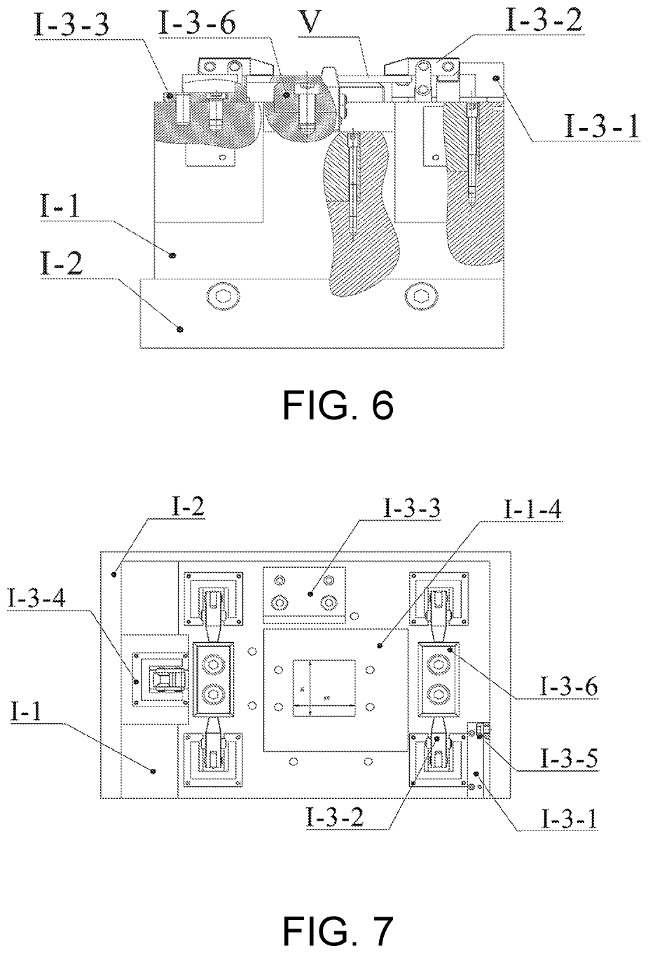

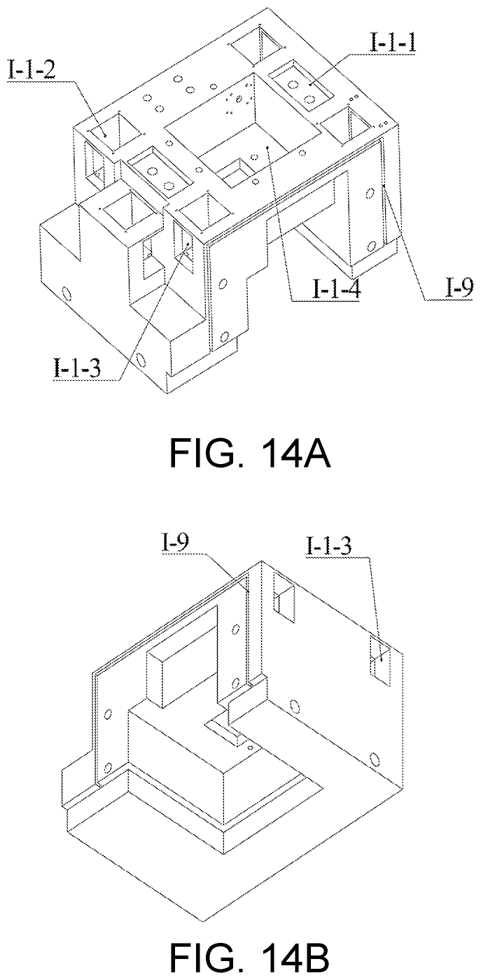

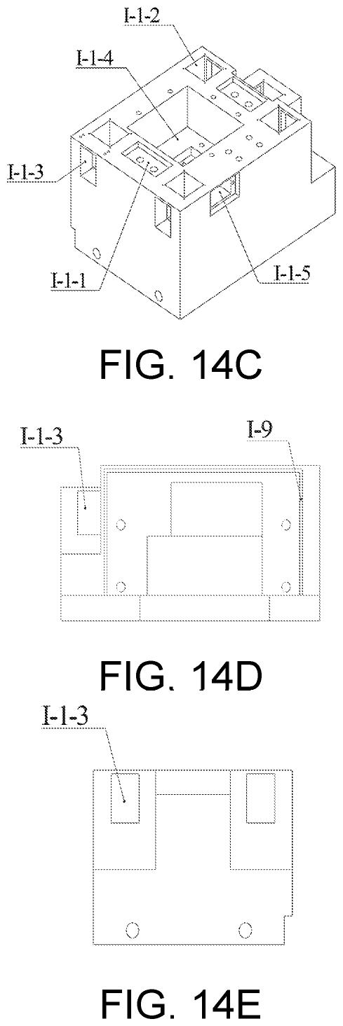

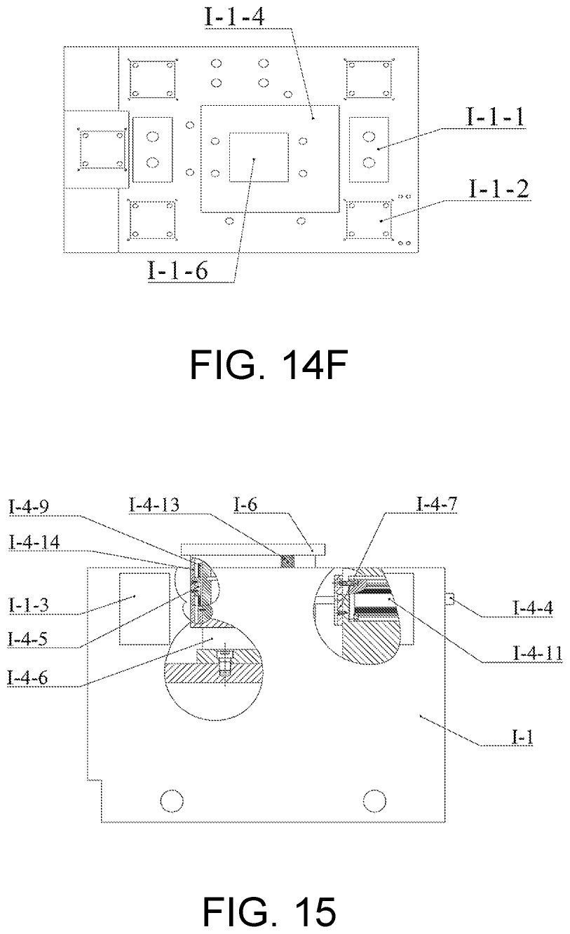

As shown in FIG. 5, FIG. 6, FIG. 7, FIG. 14 (a), FIG. 14 (b), FIG. 14 (c), FIG. 14 (d), FIG. 14 (e) and FIG. 14 (f), the clamp body shell I-1 comprises support plate fixing slots I-1-1, a hydraulic mechanism fixing slot I-1-2, hydraulic system grooves I-1-3, an internal cavity groove I-1-4, a motor groove I-1-5, and a detection hollowed area I-1-6; and two support plates I-3-6 are respectively mounted on two support plate fixing slots I-1-1. The upper sides of the support plates I-3-6 are in contact with the bottom surface of the acrylic glass workpiece V, limiting its three degrees of freedom to play the role of the bottom surface positioning. A first positioning plate I-3-1 and a second positioning plate I-3-3 are mounted and fixed on the clamp body shell I-1, and a positioning nail I-3-5 is mounted on the second positioning plate I-3-3. One end of the acrylic glass workpiece V is in contact with the first positioning plate I-3-1, and the other end is in contact with the positioning nail I-3-5, which respectively limits the two degrees of freedom and one degree of freedom of the acrylic glass workpiece V, thus limiting a total of six degrees of freedom to play the role of complete positioning. Five micro-hydraulic clamping mechanisms I-3-2 are mounted and fixed in the corresponding hydraulic mechanism fixing slots I-1-2, the hydraulic system grooves I-1-3 are used for the micro-hydraulic clamping mechanisms I-3-2 to connect the external hydraulic system, wherein in four micro-hydraulic clamping mechanisms I-3-2 which are symmetrical in the middle play a clamping role on the positioned acrylic glass workpiece V, the other micro-hydraulic clamping mechanisms I-3-2 standing sideways is used for the grinding wheel IV to play a side thrust and fixing role on the grinding of the acrylic glass workpiece V.

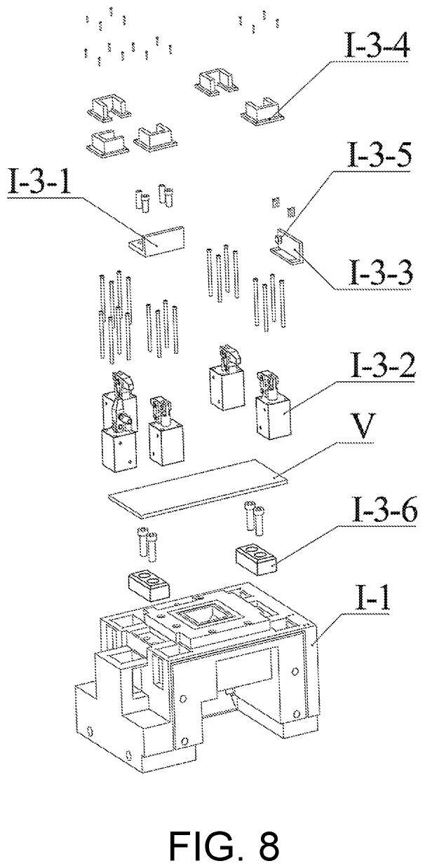

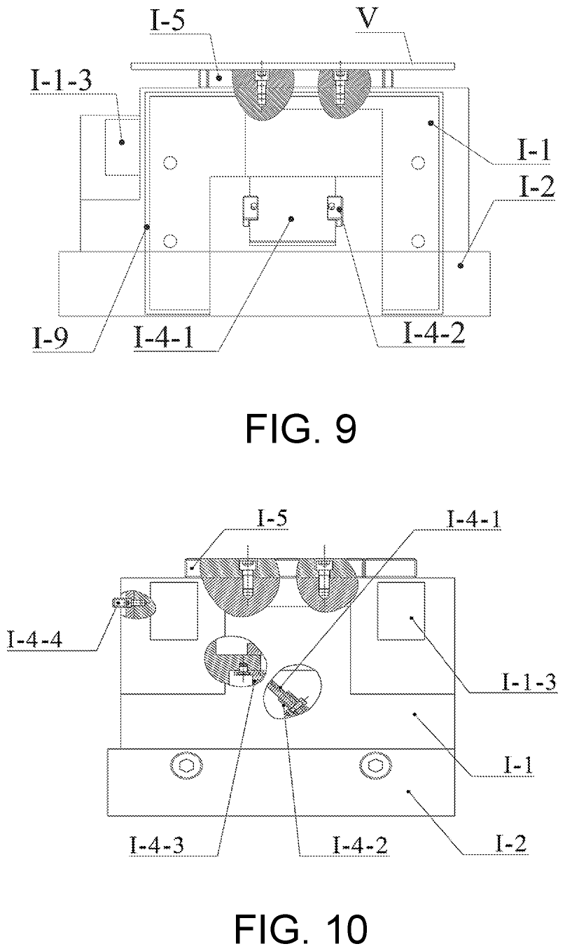

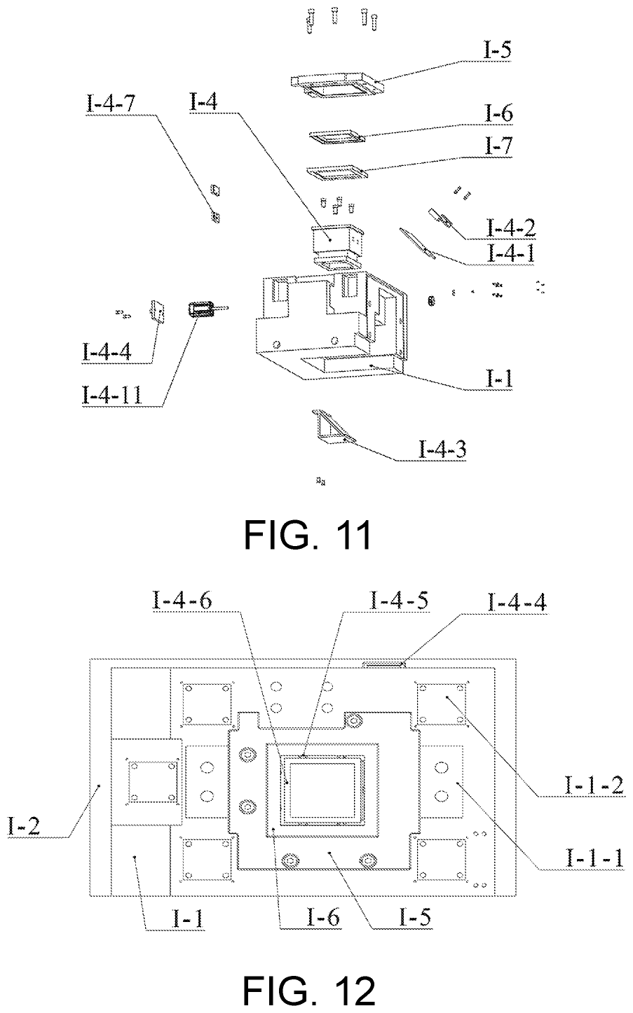

As shown in FIG. 8, FIG. 9, FIG. 10, FIG. 11 and FIG. 12, a boss I-4-6 is mounted in an internal cavity groove I-1-4, and the boss I-4-6 is a square internal hollowed structure I-4-6-1, which is equal in size to and faces the detection hollowed area I-1-6. The 45-degree flat mirror I-4-1 is fixed on a flat mirror bottom plate I-4-3 through a flat mirror splint I-4-2, and the flat mirror bottom plate I-4-3 is mounted at the bottom of the detection hollowed area I-1-6 and placed at the bottom of the boss I-4-6 square internal hollowed structure I-4-6-1 in a direct opposition manner, so that the horizontal field of view of the 45-degree plat mirror I-4-1 is greater than or equal to the size of the detection hollowed area I-1-6, which can be used for optical imaging of an infiltration condition of the grinding fluid from the bottom during the grinding, and can also facilitate the integrity of the optical imaging.

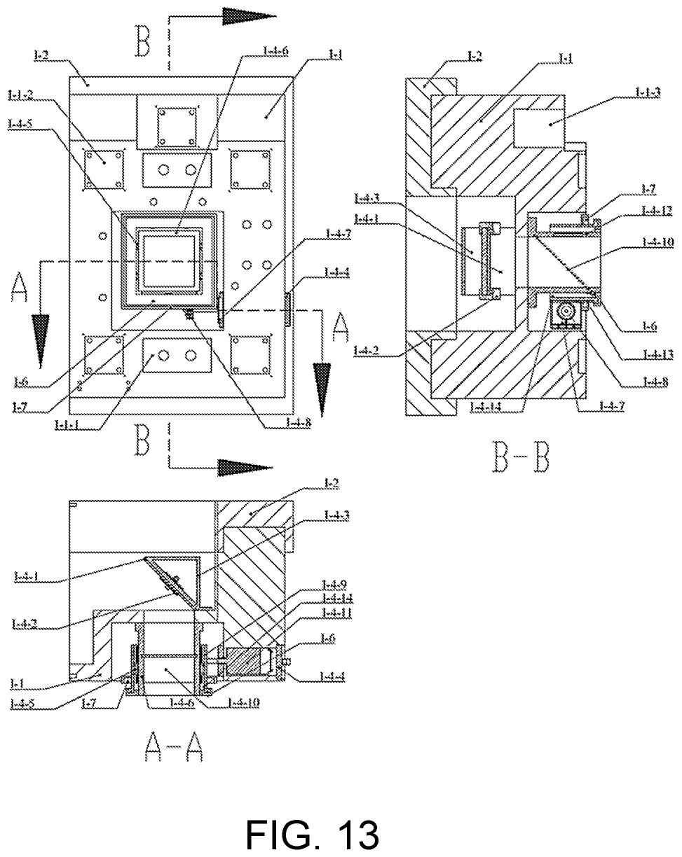

As shown in FIG. 13 and FIG. 15, guide rails I-4-9 are mounted on the front and rear sides of the boss I-4-6, and two guide rails I-4-9 are mounted on one side, and two guide rail slide blocks I-4-5 are also mounted on the front and rear sides of a moving platform I-4-14. Under sliding cooperation of the guide rail slide blocks I-4-5 and the guide rails I-4-9, the moving platform I-4-14 can be moved along a vertical direction of the boss, the other side of the moving platform I-4-14 is mounted with a gear rack I-4-13, a first micro motor I-4-11 and two bilaterally symmetrical motor sealing plates I-4-7 are mounted inside one side of the clamp body shell I-1, and a motor cover I-4-4 is mounted in the motor groove I-1-5. The two bilaterally symmetrical motor sealing plates I-4-7 and the motor cover I-4-4 seal the front and rear ends of the first micro motor I-4-11 respectively. The shaft of the first micro motor I-4-11 is connected with a gear I-4-8, and the gear I-4-8 is matched with the gear rack I-4-13 to drive the moving platform I-4-14 to automatically move in a vertical direction of the boss I-4-6. The boss sealing plate I-5 is mounted on the clamp body shell I-1, which can seal the internal cavity groove I-1-4. The boss sealing plate I-5 is also a square hollowed structure. The second sealing strip I-7 is mounted in a bottom groove I-5-1 of the boss sealing plate and is cooperated with the boss sealing plate I-5, so as to make good sealing between the internal cavity groove I-1-4 and the boss I-4-6. The first sealing strip I-6 is mounted on the top of the moving platform I-4-14, and a square size outside the first sealing strip I-6 is equal to the size of a square hollowed area inside the boss sealing plate I-5. A distance from the bottom of the first sealing strip I-6 to the top of the second sealing strip I-7 is greater than a horizontal downward movement distance of the moving platform I-4-14. A distance from the bottom of the first sealing strip I-6 to the top of the boss sealing plate I-5 is greater than a horizontal upward movement distance of the moving platform I-4-14, so under a drive control of the first micro motor I-4-11, the moving platform I-4-14 can move upward within the accuracy range, and the first sealing strip I-6 on the top plays a good sealing role in contact with the bottom of the acrylic glass workpiece V, preventing the lubrication fluid and chips from entering the boss I-4-6 inside to affect the optical system.

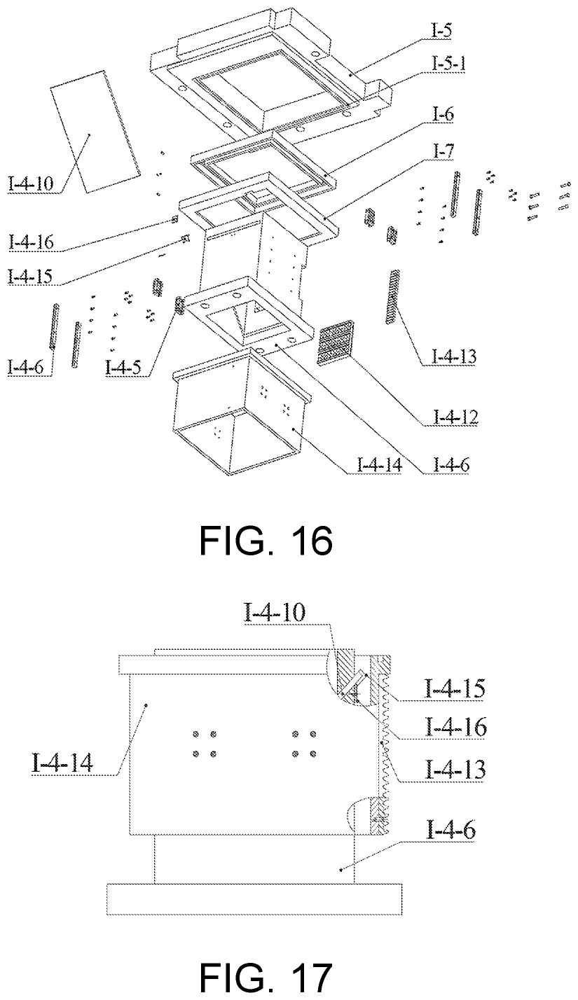

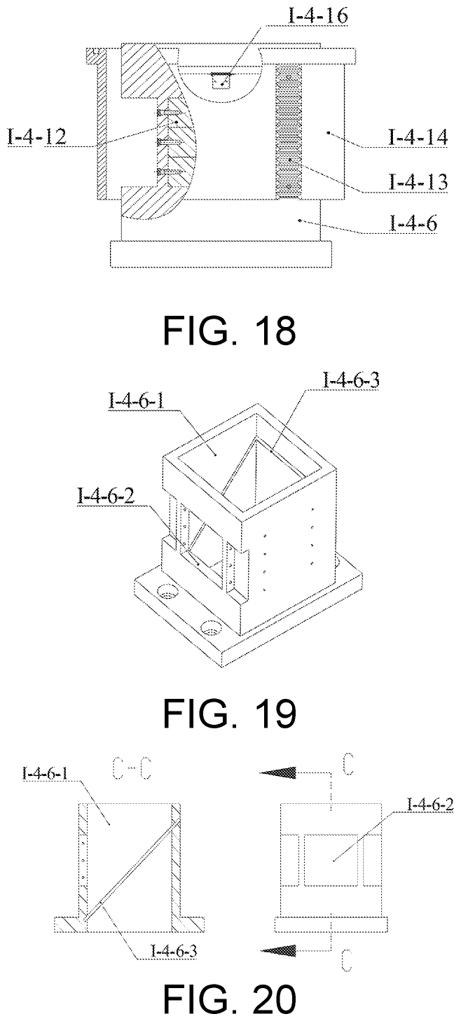

As shown in FIG. 16, FIG. 17, FIG. 18, FIG. 19 and FIG. 20, the inner part of the boss I-4-6 is a chute structure I-4-6-3, and the spectroscope I-4-10 is mounted in the chute structure I-4-6-3. Both the bottom and side of the spectroscope I-4-10 are in good contact with the chute structure I-4-6-3. The upper protruding end is abutted against and fixed by a spectroscope stopper I-4-15, and the spectroscope stopper I-4-15 is connected with a spectroscope stopper bottom plate I-4-16, and the spectroscope stopper bottom plate I-4-16 is mounted on the right side of the boss I-4-6, which is convenient for disassembly and installation of the spectroscope I-4-10 in a later period. The inside of the left end of the boss I-4-6 is a side hollowed structure I-4-6-2, and the controllable LED light strip I-4-12 is mounted in the side hollowed structure I-4-6-2, and the size thereof is equal to the size of the side hollowed structure I-4-6-2. The controllable LED light strip I-4-12 is used to provide enough lighting intensity. Under the cooperation of the good sealing and the spectroscope I-4-10, the coaxial light lighting technology can make a grinding zone needed to be detected at the bottom of the acrylic glass workpiece V eliminate reflection and increase the clarity of later imaging, and the external remote control can control turning on and turning off and brightness changes thereof as needed.

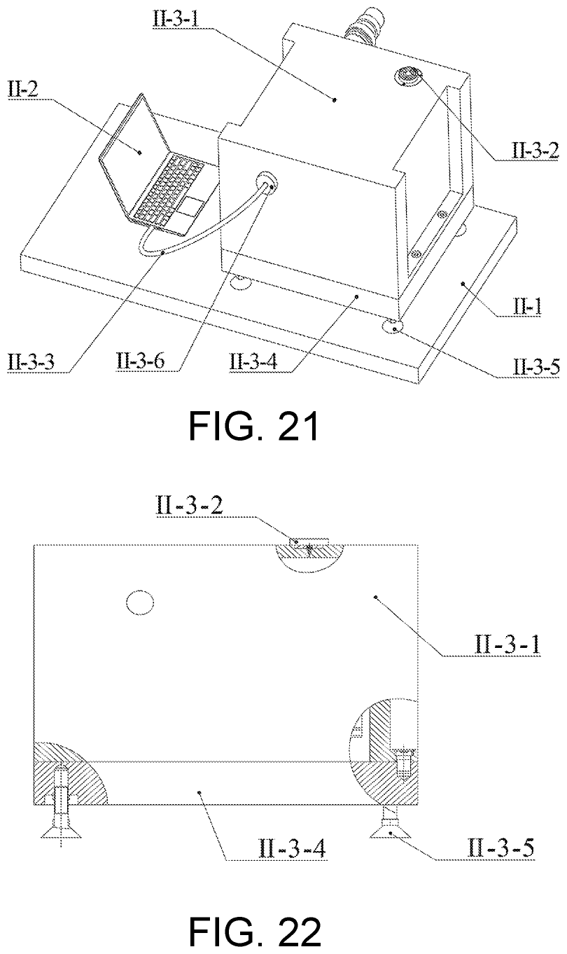

As shown in FIG. 21 and FIG. 22, the optical detection system structure II comprises a placing platform II-1, a computer II-2, a box body II-3, a lead screw moving platform II-4, a detection mirror group II-5 and a connecting rotary buckle II-6. The box body II-3 comprises a box body II-3-1, a circular gradienter II-3-2, a data line II-3-3, a box body chassis II-3-4, adjustable legs II-3-5 and a plug II-3-6. The box body II-3-1 is mounted in the box body chassis II-3-4. Four adjustable legs II-3-5 are mounted at the bottom of the box body chassis II-3-4, and the adjustable legs II-3-5 are in contact with the placing platform II-1 to ensure the stability of the overall box body II-3. The circular gradienter II-3-2 is mounted in the upper end of the box body II-3-1, so as to verify whether the box body II-3-1 is horizontal. The computer II-2 is arranged on one side of the placing platform II-1, and is connected with a high-speed camera/thermal imaging camera II-5-1 through the data line II-3-3, and a hole of the box body data line II-3-3 is sealed with the plug II-3-6.

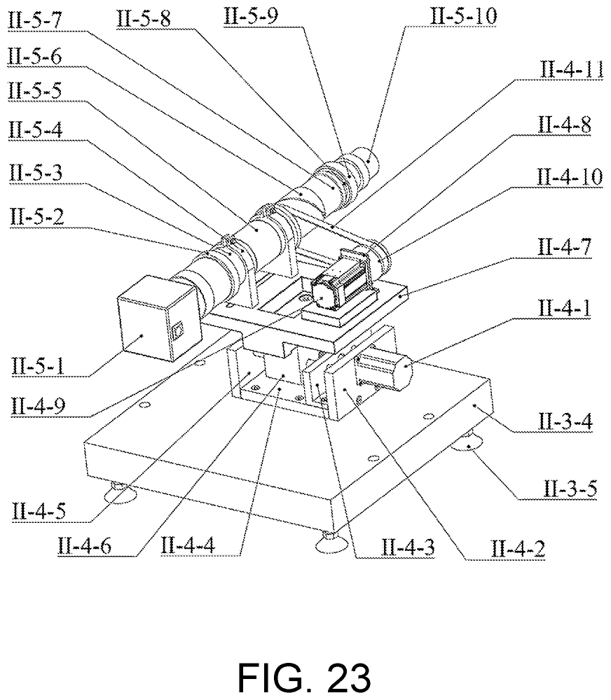

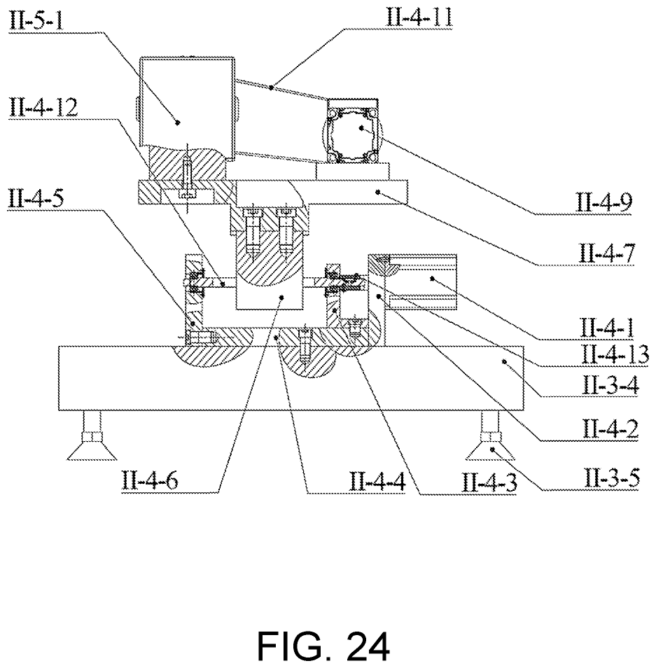

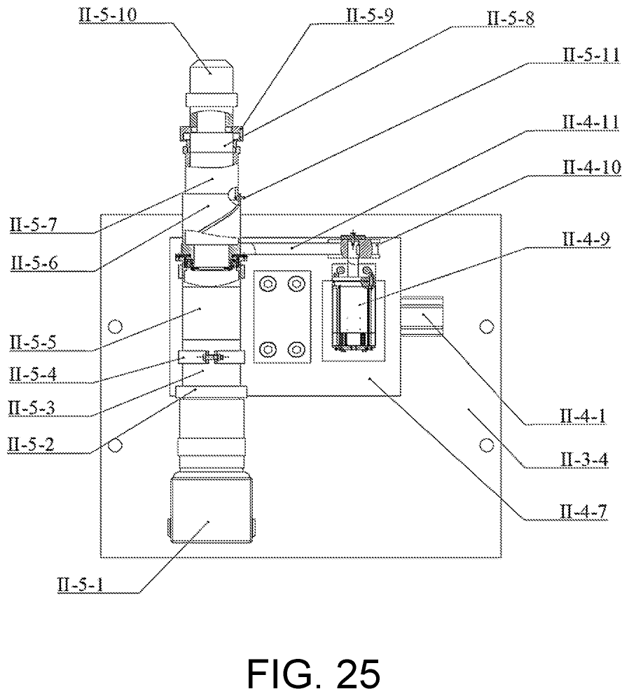

As shown in FIG. 23, FIG. 24 and FIG. 25, the lead screw moving platform II-4 comprises a second micro motor II-4-1, a first motor seat II-4-2, a first bearing seat II-4-3, a connecting bottom plate II-4-4, a second bearing seat II-4-5, a moving platform bottom plate II-4-6, a moving platform II-4-7, a second motor seat II-4-8, a third micro motor II-4-9, a pulley II-4-10, a synchronous belt II-4-11, a lead screw II-4-12, and a coupling II-4-13. A detection mirror group II-5 comprises the high-speed camera/thermal imaging camera II-5-1, a camera adapter ring II-5-2, a first extension cylinder II-5-3, an anchor ear II-5-4, a second extension cylinder II-5-5, a first focusing cylinder component II-5-6, a second focusing cylinder component II-5-7, a tube mirror II-5-8, an infinite objective lens adapter ring II-5-9, an infinite objective lens II-5-10, and a fixing pin II-5-11. The connecting bottom plate II-4-4 is fixed in the box body II-3-1, the first bearing seat II-4-3 and the first motor seat II-4-2 are mounted on both sides of the connecting bottom plate II-4-4, the second bearing seat II-4-5 is mounted on the connecting bottom plate II-4-4. The lead screw II-4-12 passes through the moving platform bottom plate II-4-6 and is connected and fixed with the first bearing seat II-4-3 and the second bearing seat II-4-5. The second micro motor II-4-1 is mounted on the first motor seat II-4-2. A shaft of the second micro motor II-4-1 is connected with one end of the lead screw II-4-12 through the coupling II-4-13. The moving platform II-4-7 is fixed on the upper end of the moving platform bottom plate II-4-6. The detection mirror group II-5 as a whole is fixed on the moving platform II-4-7 by the anchor ear II-5-4. Therefore, under a drive control of the second micro motor II-4-1, the moving platform II-4-7 can move left or right along the lead screw II-4-12 within the accuracy range, and the detection mirror group II-5 as a whole can also realize control movement in left and right directions within the accuracy range, which is convenient for the detection of the infiltration condition of the lubrication fluid. The high-speed camera/thermal imaging camera II-5-1 is connected with the first extension cylinder II-5-3 and the second extension cylinder II-5-5 through the camera adapter ring II-5-2. The extension cylinder at front is fixed with the first focusing cylinder component II-5-6. The first focusing cylinder component II-5-6 is designed as a chute structure and is internally hollowed. The second focusing cylinder component II-5-7 cooperates with the fixing pin II-5-11 for a focusing movement in a horizontal direction. The second motor seat II-4-8 is fixed on one side of the moving platform II-4-7. The third micro motor II-4-9 is fixed on the second motor seat II-4-8. The shaft of the third micro motor II-4-9 is connected with the pulley II-4-10. The synchronous belt II-4-11 bypasses the bottom of the first focusing cylinder II-5-6 and the pulley II-4-10. Under the drive control of the third micro motor II-4-9, the automatic focusing of the detection mirror group II-5 in the horizontal direction within the accuracy range can be realized, which is convenient to detect the permeation and infiltration condition of the lubrication fluid. The tube mirror II-5-8 is mounted at the front end of the second focusing cylinder component II-5-7 and is connected to the infinite objective lens II-5-10 through the infinite objective lens adapter ring II-5-9. The integral detection mirror group II-5 should directly face the reflection horizontal direction of the 45-degree flat mirror I-4-1 to ensure the integrity and visibility of the later imaging.

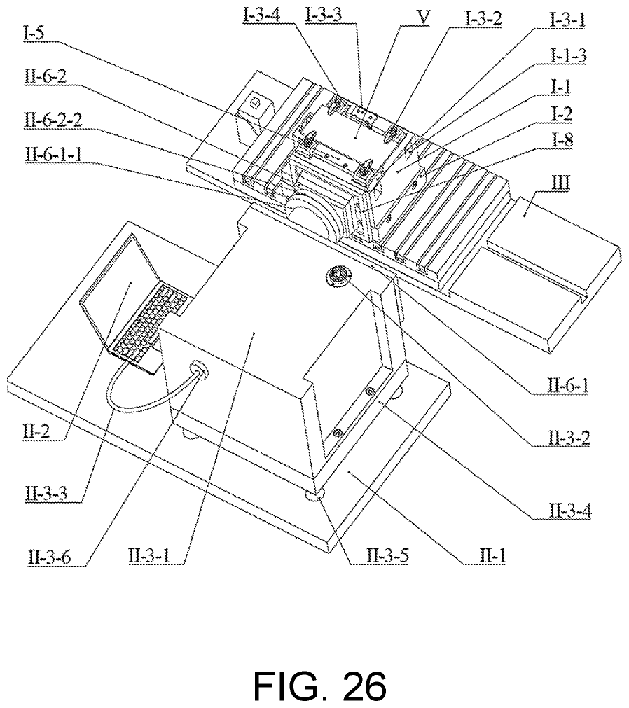

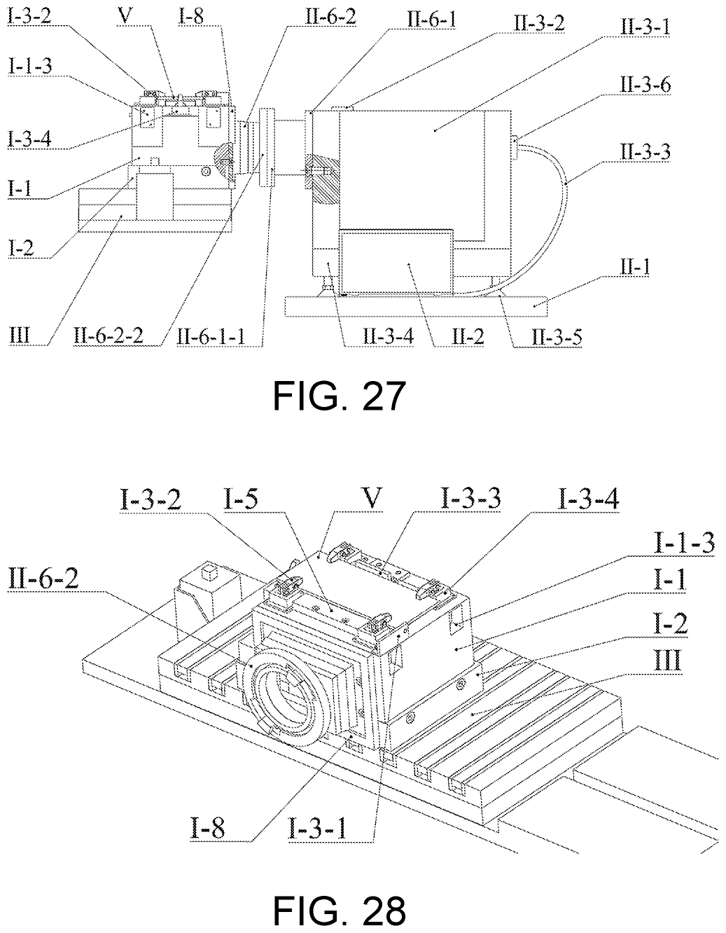

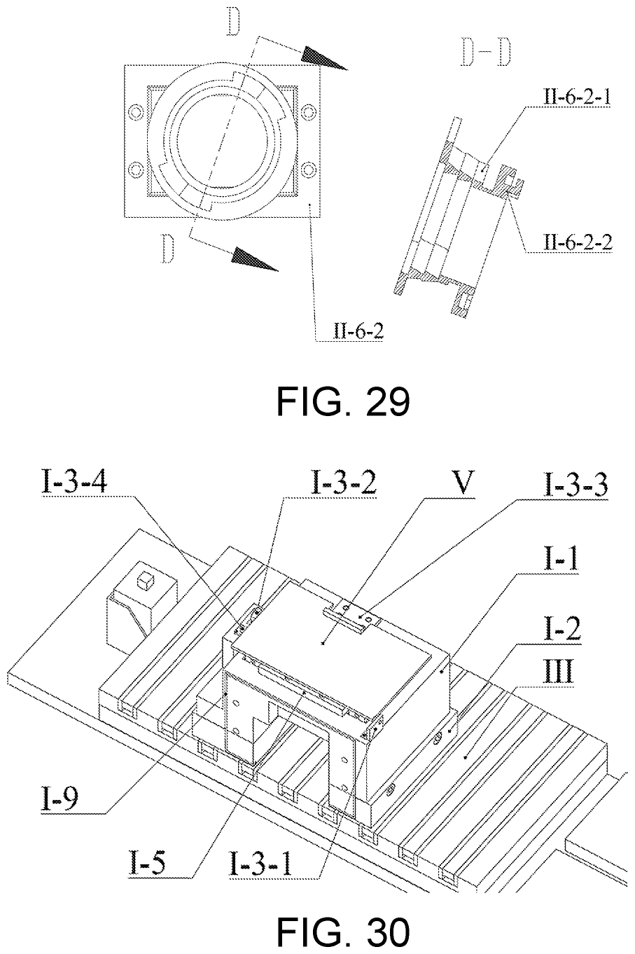

As shown in FIG. 26, FIG. 27, FIG. 28, and FIG. 29, the connecting rotary buckle II-6 comprises a detection mirror group sealing plate II-6-1, a clamp body sealing plate II-6-2, a flexible protective cover II-6-2-1, and the rotary buckle II-6-2-2. The clamp body sealing plate II-6-2 is mounted on the clamp body shell I-1 and the adsorption chassis I-2, and the third sealing strip I-8 is mounted in a shell groove I-9 and covers a part of the clamp body sealing plate II-6-2. Under the cooperation of them, it can provide a good sealing property inside the clamp body shell I-1, so as to prevent the influence of the external light and the entry of the grinding fluid and chips. The detection mirror group sealing plate II-6-1 is mounted in the front end of the box body II-3-1. The clamp body sealing plate II-6-2 comprises the flexible protective cover II-6-2-1 and the rotary buckle II-6-2-2. The rotary buckle II-6-2-2 on the clamp body sealing plate is the same size as and connected with the rotary buckle II-6-1-1 of the detection mirror group sealing plate. Therefore, the whole clamp body structure I and the optical detection system structure II are effectively combined to ensure a good sealing and detection environment.

### Second Embodiment

Disclosed in this embodiment is a dynamic collection device for an oil film and temperature distribution in a grinding zone.

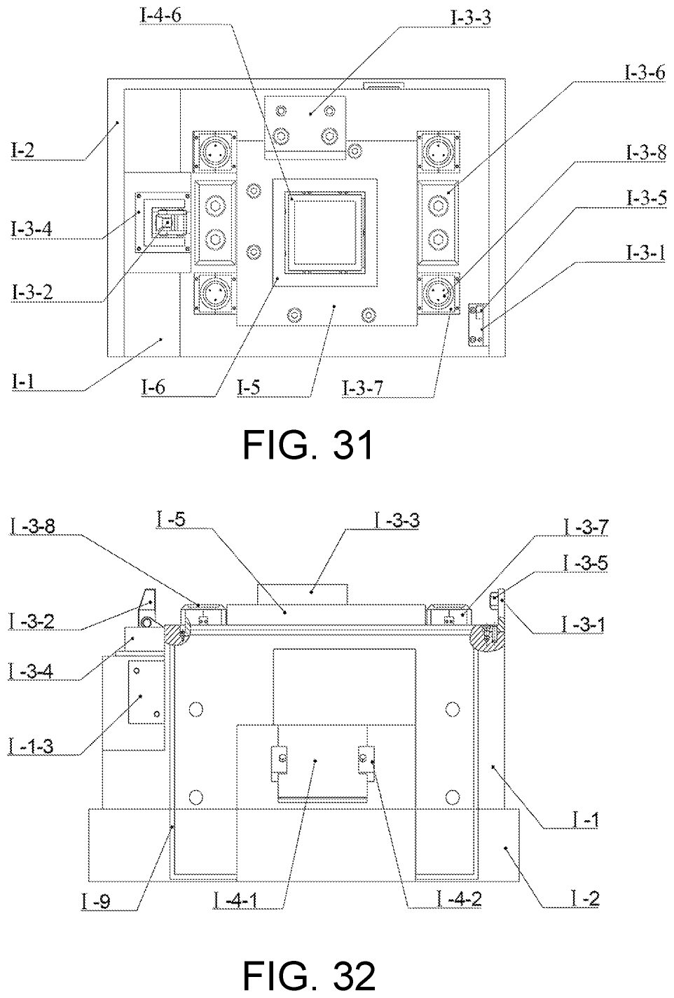

As shown in FIG. 30, FIG. 31 and FIG. 32 and compared with the first embodiment, the clamping assembly I-3 of the clamp body structure I is changed; only the left-most micro-hydraulic clamping mechanism I-3-2 of the original five micro-hydraulic clamping mechanisms I-3-2 is used, which plays the role of side thrust clamping in the grinding. The other four micro-hydraulic clamping mechanisms I-3-2 are replaced by four vacuum suckers I-3-8, the vacuum sucker fixed sealing plates I-3-7 are mounted on the clamp body shell I-1, and the vacuum suckers I-3-8 are fixed in the vacuum sucker fixed sealing plates I-3-7 and mounted at the bottom of the acrylic glass workpiece V. The vacuum suckers I-3-8 produce adsorption through an external vacuum generating device to play a fixing role in the acrylic glass workpiece V.

### Third Embodiment

Disclosed in this embodiment is an operating method of a dynamic collection device for an oil film and temperature distribution in a grinding zone.

An operating method of a dynamic collection device for an oil film and temperature distribution in a grinding zone, the method comprising:
configuring the dynamic collection device according to dynamic collection demands;
in the grinding process of the workpiece, imaging the grinding zone by utilizing the configured dynamic collection device, and carrying out the signal processing, and finally generating an image of permeation and infiltration film formation of lubrication fluid and the dynamic temperature distribution;
wherein the dynamic collection demands are divided into the permeation and infiltration film formation of the lubrication fluid and the dynamic temperature distribution.

The specific scheme in this embodiment can be realized with reference to the following contents:

Step S1: a magnetic workbench III is energized and absorbs a clamp body structure I, connects an optical detection system structure II and the clamp body structure I through a rotary buckle II-6, and uses a data line to connect a high-speed camera/thermal imaging camera II-5-1 and a screen of a computer II-2.

Step S2: an acrylic glass workpiece V is mounted and positioned and clamped with micro-hydraulic clamping mechanisms I-3-2; under a drive control of a first micro motor I-4-11, a moving platform I-4-14 is abutted against the bottom of the acrylic glass workpiece V; if an image of permeation and infiltration film formation performance of the lubrication fluid is generated, it is necessary to mount a spectroscope I-4-10 and fix it through a spectroscope stopper I-4-15, and a controllable LED light strip I-4-12 is turned on and its brightness is adjusted by an external remote control; and if a dynamic temperature distribution image is generated, it is necessary to remove the spectroscope I-4-10 and turn off the controllable LED light strip I-4-12.

Step S3: a second micro motor II-4-1 and a third micro motor II-4-9 drive and control a lead screw moving platform II-4 and telescopic focusing of a second focusing cylinder component II-5-7, respectively, so that a detection mirror group II-5 can fully image a grinding zone to the screen of the computer II-2, and this operation is a coarse adjustment.

Step S4: a grinding machine is started so that a grinding wheel IV starts grinding in the grinding zone of the acrylic glass workpiece V, and an image of the permeation and infiltration film formation of the lubrication fluid and dynamic temperature distribution begins to be generated.

Step S5: at the same time of grinding, if the accuracy of the generated image is not high, the horizontal position and focal length of the detection mirror group II-5 are carefully adjusted by the second micro motor II-4-1 and the third micro motor II-4-9 within a certain accuracy range.

Step S6: a power supply of the grinding machine, a power supply of the magnetic workbench III, the hydraulic system and the controllable LED strip are turned off after generation.

Taking magnetic field assisted deep grinding as an example, energy consumed by removing a unit material volume during the grinding is much higher than other cutting methods, and a lot of heat is generated in the grinding zone. A high grinding zone temperature would not only affect the quality of a machined surface and the service life of the grinding wheel, but also affect the performance of the lubrication fluid. Due to an increase of the grinding depth in the strong grinding, the arc length of the grinding zone is several times to dozens of times larger than that of ordinary grinding, and the characteristics of high heat generated by the negative front angle cutting of the grinding wheel particles, resulting in a significant increase in a grinding force, grinding power and grinding heat, resulting in workpiece surface burn and aggravated grinding wheel life wear. It has been shown that the applied magnetic field can significantly improve the wettability of cutting fluid in the cutting zone, and the wettability mechanism of the tool/workpiece boundary magnetic field assisted capillary channel is analyzed. A complex micro-nano channel network is formed during the grinding of the grinding wheel/workpiece interface, which is more likely to provide channels for impregnating agent. Therefore, the magnetic field is applied in the grinding zone to improve the wettability of nano-fluid at the micro-nano interface of large arc length closed grinding, and dynamic collection of its permeation and infiltration and the temperature distribution is more valuable and challenging.

In order to solve the above problems related to the permeation and infiltration performance of the lubrication fluid, the high-speed camera and thermal imaging camera are used as main detection equipments in this embodiment. The length of the acrylic glass workpiece s₀ ranges in 50-300 mm and the length s₀ is selected as 150 mm, and the width s₁ ranges in 10-200 mm and the width s₁ is selected as 60 mm. The height $2 ranges in 1-20 mm and the height s₂ is selected as 5 mm. The size of the middle hollowed area is a square of which the length x₀ and the width x₁ are both 20 mm. Due to the need for complete imaging, the horizontal length and width of the flat mirror ranges in 10-100 mm, and the flat mirror herein is selected as a 45° flat mirror of which the horizontal length and width are both 20 mm. Therefore, a distance between the permeation and infiltration detection zone and the infinite objective lens through the plane mirror imaging, that is, an object distance can be calculated as follows:

$${d}_{0} = {d}_{1} + {d}_{2} + {d}_{3}$$

In the formula, d₁ is equal to the thickness of the acrylic glass which is 5 mm, d₂ is the support length of the support plates which is 10 mm, and d₃ is the horizontal length of the flat mirror which is 20 mm, so the distance d₀ between the permeation and infiltration detection zone and the infinite objective lens through the plane mirror imaging is about 35 mm.

Since the size of the smallest object that the human eyes can see is 0.1 mm-0.2 mm, the magnetic fluid infiltration test detection device needs to reach the accuracy of a micron level, 1 μm-0.001 mm, so the overall detection device needs to be amplified about 100 times, the value of the infinite objective lens magnification α₁ ranges in 10-300 times, and magnification of 10 times is selected here, and an infinite objective lens of different magnification sizes can also be used for replacement according to needs, with a numerical aperture of 60 mm and a focal length of 200 mm. Therefore, it is necessary to use a tube mirror of 200 mm focal length in combination with the infinite objective lens, which can make a perfect correction on the aberration of the objective lens, and the combined objective lens has a wide field of view. However, since the aperture of the tube mirror is not 60 mm, an imported tube mirror Raynox DCR-150 is selected here. Its front aperture is 52 mm and the rear aperture is 43 mm, so the objective lens needs a 60 mm to 52 mm adapter ring, and the thickness of the adapter ring is about 1.5 mm. The above is a selected example, and the specific parameters need to be matched according to the parameters of the selected infinite distance objective lens.

Due to the possibility of focusing processing in a later stage, a focusing cylinder is attached behind the tube mirror, and the value of focusing cylinder ranges in 1-300 mm. The value of the focusing cylinder is selected in 28-65 mm here, which can support the tube mirror to focus in an indefinite distance under various flange distances. A distance between the focused light and a photosensitive element is far away, so an extension cylinder is needed, of which the function is to shorten the focusing distance of the lens and improve the macro performance of the lens. The length of the extension cylinder ranges in 10-100 mm. Here, one extension cylinder with a length b₁ of 30 mm and two extension cylinders with a length b₂ of 50 mm are used for superposition. Its magnification can be calculated according to the following formula:

$${n}_{0} = {n}_{1} + \frac{{L}_{1}}{{f}_{0}}$$

Where n₁ is an original magnification, L₁ is a total length of the extension cylinder, and f₀ is the focal length of the lens.

Since the entire stacked mirror group needs to be connected to the high-speed camera, an rear interface of the extension cylinder needs to be connected to an adapter ring for 52 mm to an arbitrary bayonet aperture. The selection here is based on the lens aperture of the high-speed camera. The overall detection device is too long, and it is necessary to adjust the center of gravity of the device with a quick mounting plate and an anchor ear to increase the stability of the device.

For the selection of high-speed camera frame rate requirements, because the linear speed of the grinding wheel in the magnetofluid infiltration test is 30 m/S-100 m/s, according to a calculation formula of the linear speed of the grinding wheel:

$$V = \frac{π {D}_{0} N}{1000}$$

Where D₀ is the outer diameter of the grinding wheel which is 300 mm, N is a rotation speed, the size of the rotation speed of the grinding wheel can be calculated, N₁ is about 96 r/s, N₂ is about 106 r/s, if 1/10th of rotation of the grinding wheel is 1 frame, the frame rate of the high-speed camera needs to be greater than 1100 frames, and the frame rate of the high-speed camera ranges in 500-10000 frames.

For the photosensitive element of the high-speed camera, a CCD charge coupled element is selected, of which the size ranges in ¼-1 inch, the size is selected as ⅓ inch herein, the target surface size thereof is 4.8 mm in width×3.6 mm in height, diagonal lines are of 6 mm. Because the demand of imaging, the size of the final image is needed to be greater than or equal to the diameter of the photosensitive element which is 6 mm. The magnification of the camera lens ranges in 1-20. Here, the magnification of the camera lens is selected as 1, or it can be selected within the range according to an actual situation. The size of the field of view FOV can also be calculated as follows:

FOV=sensor size/α

The sensor size is the target surface size of the CCD photosensitive element, which is 4.8 mm in width and 3.6 mm in height, so the size of the field of view FOV is also 4.8 mm in width and 3.6 mm in height.

Using a basic imaging principle formula as follows:

$$\frac{1}{f} = \frac{1}{u} + \frac{1}{v}$$

Where f is the focal length of the camera lens, u is the object distance, and v is the image distance.

According to a similar triangle principle:

$$α = \frac{d}{D} = \frac{v}{u}$$

Where α is the magnification of the camera lens, d is the diameter of the image plane which is 6 mm, D is the diameter of the object plane, so the diameter of the object plane is 6 mm.

Due to the need for convenient observation, a back-end interface of the high-speed camera would be connected to the screen of the computer, and a dynamic image on the CCD photosensitive element would be displayed on the screen of the computer, which can be calculated according to an electronic magnification formula as follows:

$${α}_{1} = \frac{{L}_{2}}{d}$$

Where L₂ is the length of the diagonal line of the screen monitor of the computer, its value ranges in 10-50 inches, which is selected as 19 inches here, d is the image plane diameter of 6 mm, so the electronic magnification is (19×25.4)/6 which is about 80.43.

The electronic magnification can then be calculated according to the following formula:

$$m = α \cdot {α}_{1}$$

Where α is the magnification of the camera lens, so the electronic magnification is 80.43.

When the dynamic temperature distribution of the grinding zone is collected, the controllable LED light strip is turned off by the external remote control, and the spectroscope is removed from the inside of a boss to avoid interference with the infrared radiation emitted from the grinding zone by an external light temperature and unnecessary reflection. The high-speed camera is replaced by a thermal imaging camera, and a grinding detection begins after the overall equipment is sealed. A camera of the thermal imaging camera transmits a signal to an internal infrared detector, the infrared detector adjusts and amplifies the received signal and outputs the amplified signal to an infrared thermal imaging chip. After a series of image processing, a temperature distribution image is imported, through the data line, into the computer screen for dynamic collection.

When the surface temperature of the object is higher than absolute zero, infrared radiation would be emitted, and the surface temperature of the measured object would directly affect the intensity of its infrared radiation energy and the distribution of energy according to the wavelength. Therefore, we can obtain the surface temperature of the object and a distribution thereof by measuring the infrared radiation of the object.

For an ideal radiation source which is the blackbody, the relationship between the radiation energy and the temperature conforms to Planck's law, that is:

$${P}_{b} ( λ T ) = \frac{{C}_{1}}{{λ}^{5}} \times \frac{1}{{e}^{\frac{{C}_{2}}{{λ}^{5}}} - 1}$$

Where: P_{b}(λT)—blackbody unit area infrared radiation power when the wavelength is λ, and a thermodynamic temperature is T, W/(cm²·μm);
C₁—a first radiation constant, C₁=37145 W/(cm²·μm),
C₂—a second radiation constant, C₂=1.4388 cm·K;

According to the formula, as the temperature of the object rises, the radiation energy increases, which is a starting point of the infrared radiation theory. At the same time, according to the Steffen-Boltzmann law, the relationship between the total power of the infrared radiation of the object and the temperature is as follows:

P=εδT⁴
Where: P—the infrared radiation power of the object, W·m⁻²;
T—the thermodynamic temperature of the object, K;
ε—infrared emissivity of the object surface;
δ—a Steffen-Boltzmann constant, 5.67×10⁻⁸ W/(m²·K⁴);

According to the Steffen-Boltzmann law, it is not difficult to find that the energy level of the infrared radiation of the object is proportional to the fourth power of its thermodynamic temperature and the surface emissivity of the object. The higher the temperature, the stronger the infrared radiation, and a slight change in the temperature of the object would significantly affect the infrared radiation intensity of the object. Therefore, the surface temperature of the object can be obtained by measuring the infrared radiation of the object.

According to an actual situation of a grinding process, through an analysis of a simplified capillary channel model of a grinding arc zone, forces that the liquid is subjected to during its ascent are a capillary driving force F_{c}, a viscous resistance Fᵥ and a gravity F_{G}.

Where the capillary driving force F_{c} can be obtained from Young-Laplace:

$$Δ P = \frac{2 γ}{{R}^{*}} = \frac{2 γcosθ}{R}$$

Where γ is a surface tension of the infiltration liquid, R″ is the radius of a capillary channel, θ is a liquid contact angle, and R is a curvature radius of the liquid surface.

The total capillary driving force is:

$${F}_{C} = Δ P \cdot π {R}^{2} = \frac{2 γcosθ}{R} \cdot π {R}^{2}$$

The viscous resistance Fᵥ can be determined by the Newton's law of internal friction in viscous fluids and the Hagen-Poiseuille equation.

According to the Newton's law of internal friction, a viscous shear force in a capillary is as follows:

$$τ = η \frac{dv}{dr} {\vert}_{r = R}$$

η is the viscosity of the liquid, v is a flow velocity of the liquid, and r is a distance from a tube wall.

The Hagen-Poiseuille equation for liquid flow in the capillary is as follows:

$$\frac{1}{r} \frac{d}{dr} ( r \frac{dv}{dr} ) = \frac{1}{η} \frac{\partial p}{\partial z}$$

Where p is a fluid pressure, z is a distance to the bottom of the capillary, performing integral to the above equation to obtain the following:

$$v = \frac{1}{4 η} ( {r}^{2} - {R}^{2} ) \frac{\partial p}{\partial z} = \frac{1}{4 η} \vert \frac{\partial p}{\partial z} \vert ( {r}^{2} - {R}^{2} )$$

$$\frac{dv}{dr} = \frac{2 r}{4 η} \cdot \frac{\partial p}{\partial z}$$

The flow rate changing along the radius in the capillary can be replaced by an average flow rate. The average flow rate is the flow rate per unit area, then:

$$\overline{v} = \frac{\dot{V}}{π {R}^{2}} = \frac{1}{π {R}^{2}} {\int }_{0}^{R} 2 π rvdr = \frac{1}{{πR}^{2}} {\int }_{0}^{R} \frac{1}{4 η} \vert \frac{\partial p}{\partial z} \vert ( {R}^{2} - {r}^{2} ) 2 π rdr = \frac{{R}^{2}}{8 η} \vert \frac{\partial p}{\partial z} \vert$$

It can be solved that:

$$\vert \frac{\partial p}{\partial z} \vert = \frac{8 η \overline{v}}{{R}^{2}}$$

$$\frac{dv}{dr} = \frac{2 r}{4 η} \cdot \vert \frac{\partial p}{\partial z} \vert = \frac{2 r}{4 η} \cdot \frac{8 η \overline{v}}{{R}^{2}}$$

At the capillary r=R

$${\frac{dv}{dr} \vert}_{r = R} = \frac{4 \overline{v}}{R}$$

$$τ = η \cdot \frac{4 \overline{v}}{R}$$

Therefore, the viscous resistance Fᵥ in the capillary is as follows:

$${F}_{V} = 2 π Rl \cdot τ = 8 π η h \overline{v}$$

Where l is the length of capillary permeation in the grinding zone. A rising height of the liquid in the capillary micro-channel in the grinding zone can be ignored, therefore:

F_{G}=0

A resultant force in capillary flowing is as follows:

$$F = {F}_{C} - {F}_{V}$$

The momentum theorem of the cooling liquid in the capillary micro-channel is as follows:

$$\frac{d ( m \overline{v} )}{dt} = F$$

Where m is the mass of the fluid, m=πR²lρ, v̅ is the average velocity of the liquid,

$$\overline{v} = \frac{\text{?}}{dt}$$

$$\text{?} \text{indicates text missing or illegible when filed}$$

and therefore:

$$\frac{d ( π {R}^{2} l ρ {l}^{′} )}{dt} = π {R}^{2} \frac{2 γ cos θ}{R} - 8 π η {ll}^{′}$$

Namely,

$$ρ \frac{d ( {ll}^{′} )}{dt} = \frac{2 γ cos θ}{R} - \frac{8 η l}{{R}^{2}} \text{?}$$

$$\text{?} \text{indicates text missing or illegible when filed}$$

Namely,

$$\frac{2 γ cos θ}{R} - \frac{8 η l}{{R}^{2}} {l}^{′} - ρ \frac{d ( {ll}^{′} )}{dt} = 0$$

When the cooling lubrication fluid permeates in the capillary micro-channel in the grinding zone, the size of different forces on the liquid at different stages would always be in a changing stage with the change of permeation time. Therefore, the liquid flowing in the capillary channels needs to be studied in different stages.

### A Stage of Inertial Force Action

When the cooling lubrication fluid just contacts the grinding zone, the viscous resistance in the flowing process is very small, and the inertial force plays a main role, then the above formula can be written as follows:

$$\frac{2 γ cos θ}{R} = ρ \frac{d ( {ll}^{′} )}{dt} = \text{?} = {ll}^{′}$$

$$\text{?} \text{indicates text missing or illegible when filed}$$

By solving this equation, we can get:

$$\text{?} = t \sqrt{\frac{2 γ cos θ}{ρ R}}$$

$$\text{?} \text{indicates text missing or illegible when filed}$$

In this stage, the permeation length of the liquid in the capillary micro-channel is linearly related to the permeation time.

### Inertia Force—Viscous Force Action Area

With the further permeation of the cooling lubrication fluid, the capillary driving force, inertia force and viscous force of the liquid in the flowing process jointly dominate the permeability of the liquid in the capillary micro-channel. Let

$$a = \frac{\text{?}}{\text{?}} ,$$

$$b = \text{?} = \frac{\text{?}}{\text{?}} ,$$

$$\text{?} \text{indicates text missing or illegible when filed}$$

then the above formula can be written as follows:

$$\frac{d ( {ll}^{′} )}{dt} + {all}^{′} = b$$

Solving this differential equation, we can get:

$${l}^{2} = \frac{2 b}{a} [ t - \frac{1}{a} ( 1 - \text{?} ) ]$$

$$\text{?} \text{indicates text missing or illegible when filed}$$

### A Stage of Viscous Force Action

With the further permeation of the liquid, the viscous resistance of the liquid in the capillary micro-channel is increasing, and the inertia force of the liquid is close to 0, then ignoring the inertia force, we can obtain:

$$\text{?} = \frac{γ \text{?} R cos θ}{2 η}$$

$$\text{?} \text{indicates text missing or illegible when filed}$$

The above are only preferred embodiments of the present invention and are not intended to limit the present invention, which may have various changes and variations for a person skilled in the art. Any modification, equivalent replacement and improvement etc. made within the spirit and principle of the present invention shall be included in the protection scope of the present invention.

To the claims:

1. A dynamic collection device for an oil film and temperature distribution in a grinding zone, wherein the dynamic collection device comprises a clamp body structure, an optical detection system structure and a magnetic workbench;
the magnetic workbench adsorbs and fixes the clamp body structure, the optical detection system structure is fixed and connected to the clamp body structure, and a workpiece is fixed on the clamp body structure; and
in a grinding process of the workpiece, the clamp body structure images the grinding zone, and transmits an image to the optical detection system structure, the optical detection system structure adjusts a lens distance and a horizontal position according to a grinding situation, and carries out a signal processing, and finally generates an image of a permeation and infiltration film formation of a lubrication fluid and an image of a dynamic temperature distribution.

2. The dynamic collection device for an oil film and temperature distribution in a grinding zone according to claim 1, wherein the clamp body structure comprises a clamp body shell, an adsorption chassis, a clamping assembly and a telescopic sealing assembly;
the clamp body shell is fixed on the adsorption chassis, and the adsorption chassis is energized and adsorbed by the magnetic workbench;
the clamping assembly is fixed on an upper surface of the clamp body shell and is used for clamping and fixing the workpiece from a side of the workpiece; and
the telescopic sealing assembly is installed in an internal cavity groove of the clamp body shell, the telescopic sealing assembly is used to abut against a bottom of the workpiece so as to form a sealing structure, and images the grinding zone through a mirror group in the sealing structure.

3. The dynamic collection device for an oil film and temperature distribution in a grinding zone according to claim 2, wherein the clamping assembly comprises a support plate, a first positioning plate and a micro hydraulic clamping mechanism mounted on the clamp body shell; and
the workpiece is placed on the support plate, and is in contact with the first positioning plate and positioning nails to achieve six-point positioning, and an upper end of the workpiece is clamped by the micro hydraulic clamping mechanism.

4. The dynamic collection device for an oil film and temperature distribution in a grinding zone according to claim 2, wherein the telescopic sealing assembly comprises a boss, a moving platform and the mirror group;
the boss is mounted in the internal cavity groove of the clamp body shell, and an inner part of the boss is a square internal hollowed structure;
the mirror group is mounted in the square internal hollowed structure of the boss, the mirror group comprises a spectroscope and a 45-degree flat mirror, wherein the spectroscope is arranged facing a detection area of the workpiece, and the 45-degree flat mirror is vertically placed at a bottom of the spectroscope; and
the moving platform is mounted on a side of the boss, and is driven by a motor to rise vertically along the boss to abut against the bottom of the workpiece; and the moving platform, the boss and the workpiece form the sealing structure.

5. The dynamic collection device for an oil film and temperature distribution in a grinding zone according to claim 1, wherein the optical detection system structure comprises a lead screw moving platform, a detection mirror group and a connecting rotary buckle;
the detection mirror group is fixed on the lead screw moving platform, and controls left and right movements of the detection mirror group by the lead screw moving platform; and
the connecting rotary buckle is used to fix and be connected with the clamp body structure, so that the detection mirror group on the lead screw moving platform is facing a mirror group in the clamp body structure.

6. The dynamic collection device for an oil film and temperature distribution in a grinding zone according to claim 5, wherein the lead screw moving platform adopts a motor lead screw mechanism to control a rotating distance of a lead screw through a motor, so that the lead screw moving platform moves within a range of micron level, and adjusts a position of the detection mirror group according to dynamic collection demands.

7. The dynamic collection device for an oil film and temperature distribution in a grinding zone according to claim 5, wherein the detection mirror group comprises an infinite-distance objective lens, a focusing cylinder, an extension cylinder, a camera and an imaging element successively connected;
wherein the camera is a high-speed camera or a thermal imaging camera, and the imaging element is a CCD photosensitive element or an infrared thermal imaging chip, and the high-speed camera and the CCD photosensitive element are used when collecting the permeation and infiltration film formation of the lubrication fluid, and the thermal imaging camera and the infrared thermal imaging chip are used when collecting the dynamic temperature distribution.

8. An operating method based on the dynamic collection device for the oil film and temperature distribution in the grinding zone according to claim 5, characterized by comprising:
configuring the dynamic collection device according to the dynamic collection demands;
in the grinding process of the workpiece, imaging the grinding zone by utilizing the configured dynamic collection device, and carrying out the signal processing, and finally generating the image of the permeation and infiltration film formation of lubrication fluid and the dynamic temperature distribution;
wherein the dynamic collection demands are divided into the permeation and infiltration film formation of the lubrication fluid and the dynamic temperature distribution.

9. The operating method based on the dynamic collection device for an oil film and temperature distribution in a grinding zone according to claim 8, wherein configuring the dynamic collection device is specifically as follows:
if the image of the permeation and infiltration film formation of the lubrication fluid is generated, mounting a spectroscope and fixing the spectroscope by a spectroscope stopper, and turning on a controllable LED light strip and adjusting brightness thereof by an external remote control; and
if the image of the dynamic temperature distribution is generated, removing the spectroscope and turning off the controllable LED strip.

10. The dynamic collection device for an oil film and temperature distribution in a grinding zone according to claim 8, wherein the dynamic collection device adjusts a horizontal position of the detection mirror group and a focal length of the detection mirror group through two ways of coarse adjustment and fine adjustment.
